(19) United States
(12) Patent Application Publication
(10) Pub. No.: US 2012/0231233 A1
(43) Pub. Date: Sep. 13, 2012

(54) DECORATIVE LIGHTWEIGHT PANEL

(76) Inventor: Shigeki KANAO, Nishinomiya-shi (JP)

(21) Appl. No.: 13/411,867

(22) Filed: Mar. 5, 2012

(30) Foreign Application Priority Data
Mar. 7, 2011 (JP) 2011-001209 U

(51) Int. Cl. B32B 5/24; B32B 33/00; B32B 5/28; B32B 13/12; B32B 13/02

(52) U.S. Cl. 428/195.1; 428/446; 428/317.9

(57) ABSTRACT

Provided is a decorative lightweight panel excellent in moisture resistance and dimensional stability, easy to be produced, and easy to be handled. The decorative lightweight panel includes a plate-shaped lightweight cement panel; a resin-reinforcing layer formed on one surface or both surfaces of the lightweight cement panel; and a decorative layer formed on the surface of the resin-reinforcing layer or on the surface of the lightweight cement panel.

### BACKGROUND OF THE INVENTION

1. Field of the Invention

The present invention relates to a panel to be used as an interior material in buildings, and more particularly to a decorative lightweight panel in which decoration is provided in its surface and carrying task and handling are easy.

2. Description of Related Art

FIG. 4 is a cross-sectional view of a main part showing a general constitution of an architectural panel.

A panel 50 in this drawing has a structure formed by bonding woody plates 52 and 52 to both surfaces of a wood frame serving as a base framework 51, and a surface decorative material 53 such as paper or a cloth is stuck to the surface of the panel 50.

With respect to indoor environments, nowadays, since air conditioning equipments have been widely used, a temperature and humidity difference between the front surface (indoor) side and the rear surface (outdoor) side of the panel 50 becomes large.

In such environments, condensation phenomena tend to occur and even if it does not lead to dew condensation, the panel 50 may be sometimes warped due to moisture absorption and it sometimes results in a problem that the panel 50 with the above-mentioned constitution is deficient in dimensional stability.

On the other hand, particularly as a panel capable of being preferably used for wet areas, a panel for an interior building material shown in FIG. 5 has been proposed.

Regarding a panel 60 for an interior building material shown in the same drawing, a decorative edge material 62 formed to have the same thickness as that of a plate-shaped interior material 61 serving as a substrate is provided on the cut end surfaces of the interior material 61, and almost all the front and rear surfaces of both interior material 61 and decorative edge material 62 are covered with exterior materials 63 and 63 (e.g., see Japanese Patent Application Publication Laid-Open No. 2001-295392).

Further, examples of the above-mentioned interior material 61 include extrusion foamed polystyrenes; example of the above-mentioned decorative edge material 62 include ABS foamed and extruded materials; and examples of the above-mentioned exterior material 63 include melamine decorative plates.

According to Japanese Patent Application Publication Laid-Open No. 2001-295392, it is described that a panel 60 for an interior building material is excellent in dimensional stability and usable as an interior material for water areas.

However, in the production of the above-mentioned panel 60 for an interior building material, first, it is required to bond the interior material 61 and the decorative edge material 62 to each other with an adhesive and then to stick the exterior material 63 to almost all the front and rear surfaces of both the interior material 61 and the decorative edge material 62 and therefore, the production is complicated and it is difficult to ensure the dimensional precision of the panel.

The present invention has been made while taking the above-mentioned problems for a conventional panel for an interior building material into consideration, and an object of the invention is to provide a decorative lightweight panel excellent in moisture resistance and dimensional stability, easy to be produced, and easy to be handled in a working site.

### SUMMARY OF THE INVENTION

The present invention provides a decorative lightweight panel comprising:

a plate-shaped lightweight cement panel;

a resin-reinforcing layer formed on one surface or both surfaces of the lightweight cement panel; and

a decorative layer formed on the surface of the resin-reinforcing layer or on the surface of the lightweight cement panel.

In the present invention, the decorative layer can be constituted with a wallpaper material.

In the present invention, the decorative layer can be constituted with a printed layer.

In the present invention, the lightweight cement panel is preferable to be constituted with a porous molded body having a large number of air bubbles in a cement cured material and a large number of reinforcing fibers dispersed therein.

In the present invention, the resin-reinforcing layer is preferable to be constituted with a fiber-reinforced resin obtained by embedding reinforcing fiber materials in a synthetic resin.

The decorative lightweight panel of the present invention has advantageous characteristics such as excellent moisture resistance and dimensional stability, simplicity of production, and easiness of handling.

### BRIEF DESCRIPTION OF THE DRAWINGS

FIG. 1 is a perspective view of a main part showing configuration of the decorative lightweight panel of the present invention.

FIG. 2 is a cross-sectional view of the decorative lightweight panel of FIG. 1.

FIGS. 3A to 3C are cross-sectional views showing modification of the decorative lightweight panel of the present invention.

FIG. 4 is a cross-sectional view of a main part showing a conventional constitution of a panel for construction.

FIG. 5 is a perspective view of a main part showing a conventional constitution of a panel for an interior architectural material.

### DETAILED DESCRIPTION OF THE PREFERRED EMBODIMENTS

Hereinafter, the present invention will be described in detail, based on embodiments shown in the drawings.

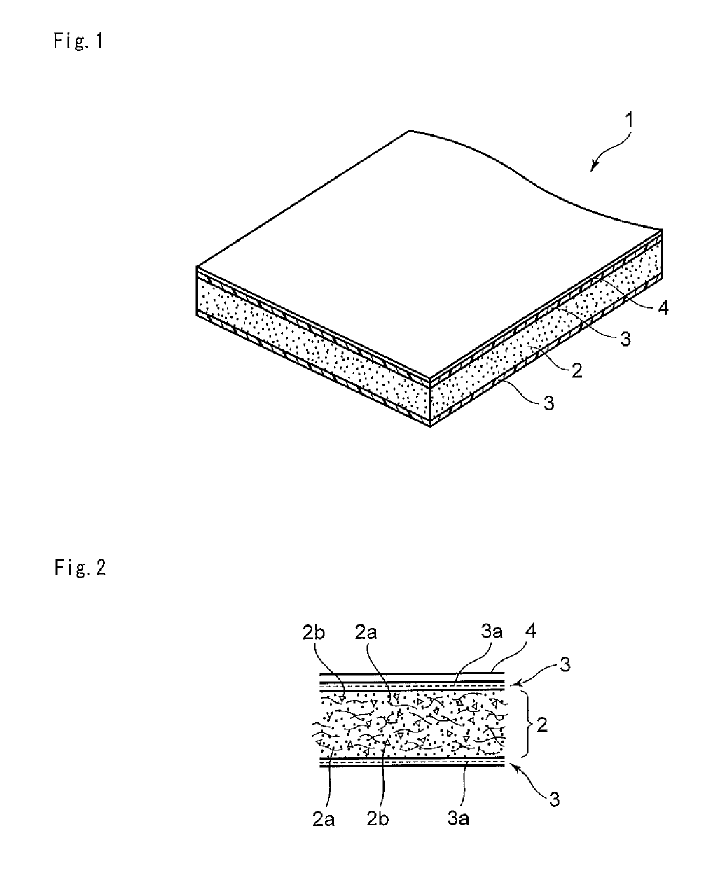

FIG. 1 is a perspective view showing a main part of the decorative lightweight panel (hereinafter, abbreviated as decorative panel) of the present invention.

In the same drawing, a decorative panel 1 is mainly composed of a plate-shaped lightweight cement panel 2, resin-reinforcing layers 3 formed on both surfaces of the lightweight cement panel 2, and a decorative layer 4 formed on the surface in one side of the resin-reinforcing layers 3 (on one side surface of the decorative panel 1).

Hereinafter, the respective constituents will be described.

### 1. Lightweight Cement Panel

In FIG. 2, the lightweight cement panel 2 has a porous structure having a large number of air bubbles 2b in the lightweight cement panel 2 and reinforcing fibers 2a dispersed therein.

A homogeneous porous structure containing the reinforcing fibers 2a can be obtained by, for example, packing cement, water, the reinforcing fibers 2a, and a foamed-shaped kneaded product generated by pre-foaming a foaming agent in a mold, followed by curing.

The kind of the above-mentioned cement is not particularly limited and various cements such as ordinary portland cement, high early strength portland cement, and ultrahigh early strength portland cement may be used; however, high early strength portland cement excellent in productivity and strength is preferable to be used.

The mixing ratio of cement and water is 20 to 100 parts by mass, preferably 20 to 50 parts by mass, per 100 parts by mass of the cement. If water is too high, the strength tends to be low and if water is too small, the fluidity of cement kneaded product at the time of molding tends to become so low as to worsen the formability.

Examples of the reinforcing fibers 2a include polyvinyl alcohol fibers (vinylon fibers), polyolefin-based fibers such as polypropylene fibers and polyethylene fibers, aramid fibers, carbon fibers, steel fibers, and glass fibers. Among these fibers, vinylon fibers are preferable since they have high durability and are excellent in affinity with cement.

The fiber length of the reinforcing fiber 2a is not particularly limited, but is preferably within the range of 4 to 35 mm. If the fiber length of the reinforcing fiber 2a is less than 4 mm, the reinforcing effect tends to be deficient.

As the fiber length of the reinforcing fiber 2a is longer, it is advantageous in terms of reinforcing effect; however, on the other hand, as the fiber length becomes longer, the dispersibility becomes lower to result in uneven existence of the reinforcing fibers 2a in the lightweight cement panel 2 and rather, it may result in a decrease in strength of the lightweight cement panel 2 in some cases.

The thickness of the reinforcing fiber 2a is not also particularly limited, and those with a thickness of 10 μm to 100 μm can be used.

The lightweight cement panel 2 having a reinforced structure in which the reinforcing fibers 2a are intertwined is obtained merely by evenly dispersing the reinforcing fibers 2a at the time of kneading cement. Consequently, in the case of producing the lightweight cement panel 2, it is unnecessary to carry out a complicated work of positioning or the like of the reinforcing fibers 2a to be embedded and it is made possible to easily produce the lightweight cement panel 2 without unevenness of the strength.

The mixing amount of the above-mentioned reinforcing fibers 2a is preferably 0.5 to 5 parts by mass per 100 parts by mass of the cement. If the mixing amount of the reinforcing fibers 2a is too small, the reinforcing effect is low and the strength of the lightweight cement 2 also becomes low.

On the other hand, as the mixing amount of the reinforcing fibers 2a becomes larger, the reinforcing effect of the lightweight cement 2 becomes higher; however, as the mixing amount of the reinforcing fibers 2a is in excess amount, the dispersibility becomes worse during kneading of the cement, and it results in uneven existence of the reinforcing fibers 2a and unevenness of the strength of the lightweight cement panel 2 and rather, it may possibly cause a decrease in strength of the lightweight cement panel 2 in some cases.

From such a viewpoint, the mixing amount of the reinforcing fibers 2a is more preferably within the range of 0.5 to 3 parts by mass per 100 parts by mass of the cement.

The foaming agent is not also particularly limited and conventionally known various foaming agents such as foaming agents for cement and concrete, for example, protein-based, surfactant-based, and resin-based foaming agents can be used.

Further, with those foaming agents, a metal-based foaming agent such as an aluminum powder may be used. The adding amount and addition method of the foaming agent are not particularly limited; however in general, the amount may be properly adjusted in the range of 0.1 to 3 parts by mass per 100 parts by mass of the cement in such a manner that the specific gravity of the resultant lightweight cement panel 2 falls to a target value of 1.0 or less.

The specific gravity of the lightweight cement panel 2 is preferably 0.5 to 1.0, more preferably in the range of 0.6 to 0.9, and most preferably about 0.7 to 0.8, which is the same as that of woody plywood.

Naturally, as the specific gravity is smaller, the lightweight cement panel 2 becomes lighter and it is easy to be handled at the time of carrying task and construction.

In addition, at the time of producing the lightweight cement panel 2, a water-reducing agent may be used properly. Examples of the water-reducing agent include, but are not particularly limited to, naphthalene-based water-reducing agent, sulfonic acid-based water-reducing agents, and polycarboxylic acid-based water-reducing agents.

Upon producing the lightweight cement panel 2, at the time of kneading cement, water, the reinforcing fibers 2a, foams generated by pre-foaming a foaming agent, other additives and the like, a conventionally known mixing machine can be used; however, it is required to evenly knead the mixture as a whole without damaging the condition of the foams generated by pre-foaming the foaming agent and the shape and dimension of the reinforcing fibers in the kneaded mixture.

If the foams by the foaming agent are damaged at the time of kneading, the sizes of air bubbles in the lightweight cement panel 2 after molding become uneven and it may result in unevenness of the strength of the lightweight cement panel 2 in some cases. Further, if the reinforcing fibers 2a are damaged and broken, it may sometimes become impossible to obtain a desired reinforcing effect.

### 2. Resin-Reinforcing Layer

The resin-reinforcing layer 3 is obtained by embedding a reinforcing material 3a in a synthetic resin layer, and hard fiber-reinforcing resin layers are formed on both surfaces of the lightweight cement panel 2.

In order to integrally form the above-mentioned resin-reinforcing layers 3 on the surfaces of the lightweight cement panel 2, after the lightweight cement panel 2 is produced, a box type frame (not illustrated) slightly larger than the outside dimension of the lightweight cement panel 2 is prepared and the lightweight cement panel 2 is set in the frame. At this time, the lightweight cement panel 2 is set while being kept slightly from the bottom surface of the frame through a spacer (corresponding to the thickness of the resin-reinforcing layer 3), and subsequently the upper aperture of the frame is closed with a cover. A gap is also secured between the lightweight cement panel 2 and the cover (corresponding to the thickness of the resin-reinforcing layer 3).

Next, the spaces between the lightweight cement panel 2 and the frame and between the lightweight cement panel 2 and the cover are filled with a liquid-state surface-reinforcing material.

The above-mentioned surface reinforcing material is a material obtained by mixing short fibers of a reinforcing material 3a with a foamable synthetic resin, and similarly to the reinforcing fibers 2a, as the reinforcing material 3a, short fibers such as polyvinyl alcohol fibers (vinylon fibers), polyolefin-based fibers such as polypropylene fibers and polyethylene fibers, aramid fibers, carbon fibers, steel fibers, and glass fibers can be used.

As another method of forming the resin-reinforcing layer 3, the resin-reinforcing layer 3 is also formed by applying a formable resin to the upper surface and lower surface of the lightweight cement panel 2, putting a sheet-shaped resin-reinforcing material formed into a woven fabric or a nonwoven fabric on the formable resin, and further applying the formable resin thereon again.

Regarding the size of the sheet-shaped resin-reinforcing material, one having approximately the same size (flat dimension) as that of the lightweight cement panel 2 is used. In order to reliably integrate the resin-reinforcing material and the cured foamable synthetic resin, a mesh type woven fabric or a nonwoven fabric in which a large number of apertures are formed is preferable to be employed as the sheet-shaped resin-reinforcing material.

Particularly, a chopped strand mat comprised of glass fibers with a Metsuke (fiber weight per unit area) of 50 to 1,000 g/m², preferably 200 to 300 g/m² is economically available and remarkably improves the rigidity of the lightweight cement panel 2 and is therefore preferable.

The above-mentioned sheet-shaped resin-reinforcing material may be sufficient if being embedded in the synthetic resin layer, and may be arranged not only in the center in the thickness direction of the synthetic resin layer but also near one of the surfaces.

When the foamable synthetic resin is cured, the resin-reinforcing layer 3 is formed and both the upper and lower surfaces of the lightweight cement panel 2 are coated with the resin-reinforcing layer 3 to be integrated.

As still another method of forming the resin-reinforcing layer 3, first, glass roving wound like a roll is unrolled and cut into short fibers with a length of, for example, about 20 mm to obtain a reinforcing material 3a comprised of the reinforcing fibers.

Next, the reinforcing material 3a is spread, using an air gun, over the upper surface of the lightweight cement panel 2 sent by a transportation apparatus (not illustrated).

Subsequently, a liquid-state synthetic resin is sprayed from a nozzle while the reinforcing material 3a is spread.

Consequently, the reinforcing material 3a is impregnated with the liquid-state synthetic resin and after curing of the synthetic resin, the resin-reinforcing layer 3 is formed.

In this way, the resin-reinforcing layers 3 are formed on both surfaces of the lightweight cement panel 2 to heighten the rigidity against bending and twisting applied to the lightweight cement panel 2 and to protect the lightweight cement panel 2 from the external force applied to the lightweight cement panel 2.

The synthetic resin for forming the resin-reinforcing layer 3 is not particularly limited, and examples thereof include polystyrene foam, polyethylene foam, rigid polyurethane foam, rigid vinyl chloride foam, urea foam, phenol foam, acrylic foam, cellulose acetate foam, and other foamable synthetic resins.

The foaming magnification of the above-mentioned synthetic resin is not particularly limited and it is generally about 2 to 10 times. As the foaming magnification of the synthetic resin is lower, the strength of the lightweight cement panel 2 becomes larger, and on the other hand, the weight of the lightweight cement panel 2 also becomes larger.

As the foaming magnification of the synthetic resin is higher, the lightweight cement panel 2 becomes lighter, but on the other hand, the strength of the lightweight cement panel 2 tends to be lowered. Consequently, the foaming magnification of the synthetic resin is determined in consideration of the lightweight properties, strength, and impact resistance of the lightweight cement panel 2.

The synthetic resin for forming the resin-reinforcing layer 3 is not limited to the above-mentioned foaming synthetic resins, and examples to be used include a polystyrene resin, a polyethylene resin, a rigid polyurethane resin, a flexible polyurethane resin, a rigid vinyl chloride resin, a urea resin, a phenol resin, an acrylic resin, a cellulose acetate resin, other non-foamable synthetic resins. In this case, the above-mentioned synthetic resin is applied to both surfaces of the lightweight cement panel 2 in such a manner that each thickness ensures about 1 to 4 mm.

In this embodiment, the present invention is described referring to the case of forming the resin-reinforcing layers 3 on both surfaces of the lightweight cement panel 2; however in the case where a decorative layer described below serves as the resin-reinforcing layer, the resin-reinforcing layer may be formed only one surface of the lightweight cement panel 2 (surface in the side where no decorative layer is formed).

### 3. Decorative Layer

The decorative layer 4 can be formed by sticking a wallpaper material as an interior material and can be also formed by printing process or application.

### 3.1 Wallpaper Material

As the wallpaper material, (a) vinyl wallpaper having abundant designs and colors such as grain patterns, flower patterns, and geometric patterns; (b) wallpaper formed by sticking fiber fabrics to substrate surface; (c) cork sheets; and the like can be used. The wallpaper material may also be one obtained by laminating a protection film on the surface of the wallpaper or one obtained by providing the surface with irregularities.

The wallpaper and cork sheet are stuck to the surface of the resin-reinforcing layer 3 using an adhesive for wallpaper.

### 3.2 Printing Process

The decorative layer 4 may also be formed by printing process.

In the case of printing, for example, grains as the decorative layer 4, an inkjet printing apparatus is used.

A common inkjet printing apparatus is equipped with an inkjet head for ejecting an ink (hereinafter, abbreviated as head), an ink cartridge for supplying an ink to the head, a carriage for scanning the head, and a feeding mechanism for feeding the lightweight cement panel 2 bearing the resin-refining layer 3 in the direction orthogonal to the scanning direction of the head.

Droplets of the ink ejected from the head are deposited on the resin-reinforcing layer 3 of the lightweight cement panel 2 arranged at a gap of about 1 mm from the head. Consequently, desired patterns, for example, grain patterns can be printed.

In common inkjet, droplets of an ink are deposited on paper and penetrate the paper to fix patterns, and in the case where an object to be printed is a resin material, unlike paper, since the resin material has no wettability, the ink to be used for inkjet is of a thermosetting resin with good compatibility with the resin material.

Even if the resin material has no acceptability, in the case where the ink material is a thermosetting resin, the ink material can be cured on the surface without penetrating the resin-reinforcing layer 3 and can be fixed in the resin-reinforcing layer 3.

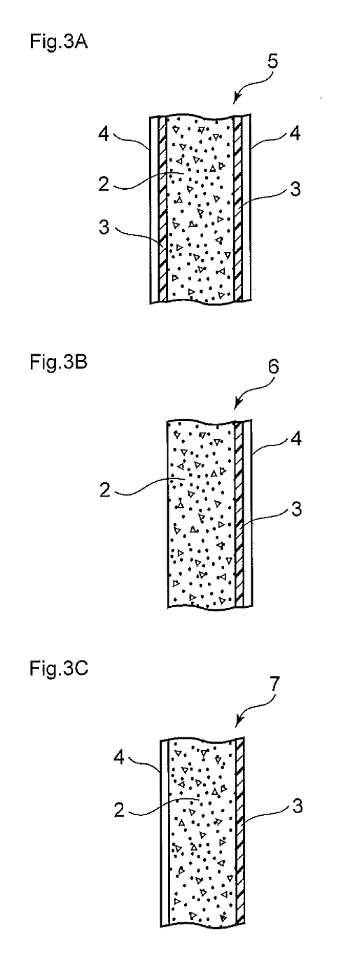

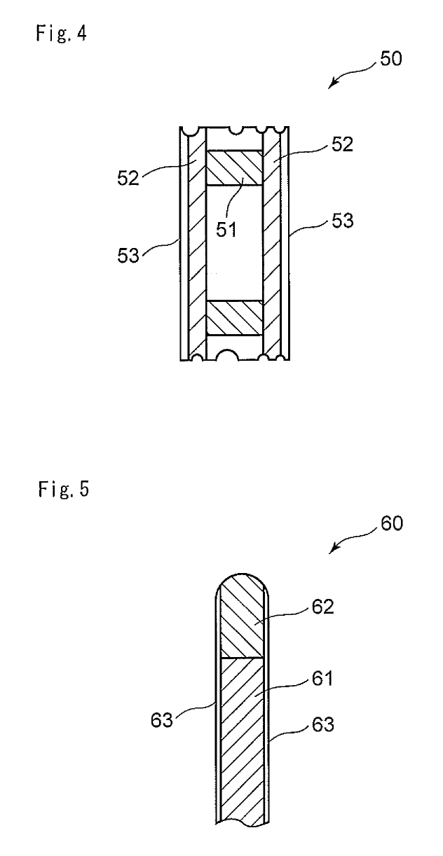

FIGS. 3A to 3C show modification of the decorative panel of the present invention.

In these drawings, the same symbols are assigned for the constituent elements that are the same as those in FIG. 1 and their explanations will not be given.

A second decorative panel 5 shown in FIG. 3A has the decorative layers 4 on both surfaces of the lightweight cement panel 2.

This kind of decorative panel 5 can be used as a partition wall matched with the design of a wall.

A third decorative panel 6 shown in FIG. 3B has the resin-reinforcing layer 3 only on one surface of the lightweight cement panel 2 and the decorative layer 4 formed on the surface of the resin-reinforcing layer 3.

This kind of decorative panel 6 can be used in the case where another member is to be bonded further to the rear surface thereof.

A fourth decorative panel 7 shown in FIG. 3C has the decorative layer 4 formed directly on the surface of the lightweight cement panel 2 on which the resin-reinforcing layer 3 is not formed.

In the case where the decorative layer 4 itself has strength and shows rigidity when stuck to the lightweight cement panel 2 to be integrated, the decorative layer 4 may be formed directly on the surface of the lightweight cement panel 2.

The decorative panel of the present invention can also be configured by forming an undercoat layer on one surface of the lightweight cement panel 2, forming a decorative layer on the undercoat layer through a UV-curable coating material, and forming a top coat layer on the decorative layer of the UV-curable coating material.

The invention of the present application claims priority based on Japanese Utility Model Registration Application No. 2011-1209 filed on Mar. 7, 2011. The entire content of the specification of Japanese Utility Model Registration Application No. 2011-1209 filed on Mar. 7, 2011 is incorporated into the present application by reference.

1. A decorative lightweight panel comprising:
a plate-shaped lightweight cement panel;
a resin-reinforcing layer formed on one surface or both surfaces of the lightweight cement panel; and
a decorative layer formed on the surface of the resin-reinforcing layer or on the surface of the lightweight cement panel.

2. A decorative lightweight panel comprising:
a plate-shaped lightweight cement panel;
a resin-reinforcing layer formed on one surface or both surfaces of the lightweight cement panel; and
a decorative layer formed on the surface of the resin-reinforcing layer or on the surface of the lightweight cement panel, wherein
the decorative layer is comprised of a wallpaper material.

3. A decorative lightweight panel comprising:
a plate-shaped lightweight cement panel,
a resin-reinforcing layer formed on one surface or both surfaces of the lightweight cement panel; and
a decorative layer formed on the surface of the resin-reinforcing layer or on the surface of the lightweight cement panel, wherein
the decorative layer is comprised of a printed layer.

4. The decorative lightweight panel according to claim 1, wherein the lightweight cement panel is comprised of a porous molded body having a large number of air bubbles in a cement cured material and a large number of reinforcing fibers dispersed therein.

5. The decorative lightweight panel according to claim 1, wherein the resin-reinforcing layer is constituted with a fiber-reinforced resin obtained by embedding reinforcing fiber materials in a synthetic resin.

6. The decorative lightweight panel according to claim 4, wherein the resin-reinforcing layer is constituted with a fiber-reinforced resin obtained by embedding reinforcing fiber materials in a synthetic resin.

7. The decorative lightweight panel according to claim 2, wherein the lightweight cement panel is comprised of a porous molded body having a large number of air bubbles in a cement cured material and a large number of reinforcing fibers dispersed therein.

8. The decorative lightweight panel according to claim 3, wherein the lightweight cement panel is comprised of a porous molded body having a large number of air bubbles in a cement cured material and a large number of reinforcing fibers dispersed therein.

9. The decorative lightweight panel according to claim 2, wherein the resin-reinforcing layer is constituted with a fiber-reinforced resin obtained by embedding reinforcing fiber materials in a synthetic resin.

10. The decorative lightweight panel according to claim 3, wherein the resin-reinforcing layer is constituted with a fiber-reinforced resin obtained by embedding reinforcing fiber materials in a synthetic resin.

11. The decorative lightweight panel according to claim 7, wherein the resin-reinforcing layer is constituted with a fiber-reinforced resin obtained by embedding reinforcing fiber materials in a synthetic resin.

12. The decorative lightweight panel according to claim 8, wherein the resin-reinforcing layer is constituted with a fiber-reinforced resin obtained by embedding reinforcing fiber materials in a synthetic resin.
